(19) United States
(12) Patent Application Publication
(10) Pub. No.: US 2020/0190314 A1
(43) Pub. Date: Jun. 18, 2020

(54) DUAL CURE EXTENDED POT LIFE EPOXY COMPOSITION

(71) Applicant: Jeffrey R. Maier, Park City, UT (US)

(72) Inventor: Jeffrey R. Maier, Park City, UT (US)

(21) Appl. No.: 16/708,552

(22) Filed: Dec. 10, 2019

Related U.S. Application Data
(60) Provisional application No. 62/779,223, filed on Dec. 13, 2018.

(51) Int. Cl. C08L 63/04; C08K 5/1539; C08K 5/17; C08K 5/132

(52) U.S. Cl. CPC C08L 63/04; C08K 5/1539; C08K 5/17; C08L 2203/18; C08L 2312/06; C08L 2203/16; C08L 2205/03; C08K 5/132

(57) ABSTRACT

A delayed curing epoxy resin composition and method for installing a pipe liner that allows the liner to be fully wet out with a delayed curing resin and photoinitiated and thermal activators and stored for a period of up to six months prior to installation and curing through exposure to ultraviolet light energy, thermal energy, or combination of both. Further, disclosed is a method of lining a pipe with a delayed curing resin composition that includes fully wetting out a liner with a blended two-part epoxy composition such that the liner can be transported in a wet out fashion, placed in a pipe to be lined and repositioned as needed without concern for the resin composition to begin curing.

### CROSS-REFERENCE TO RELATED APPLICATIONS

This application is related to and claims priority from earlier filed U.S. Provisional Patent Application No. 62/779,223, filed Dec. 13, 2018.

### BACKGROUND OF THE INVENTION

The present invention generally relates to a delayed curing resin composition. More specifically, the present invention relates to an epoxy resin composition that allows the resin and catalysts to be mixed without commencing a cure reaction for an extended period, creating a long pot life composition that cures only when subjected to elevated temperature, exposure to ultraviolet light energy, or a combination of both.

Generally, epoxy coatings are well known in the art, and due to their exceptional durability and structural properties, epoxy based protective coatings have gained commercial acceptance as protective and decorative coatings for use on a wide variety of materials. For example, epoxy based protective coatings represent one of the most widely used methods of corrosion control. They are used to provide long term protection of steel, concrete, aluminum and other structures under a broad range of corrosive conditions, extending from atmospheric exposure to full immersion in highly corrosive environments. Further, epoxy coatings are readily available and are easily applied by a variety of methods including spraying, rolling and brushing. They adhere well to steel, concrete and other properly prepared substrates, have low moisture vapor transmission rates and act as barriers to water, chloride and sulfate ion ingress, provide excellent corrosion protection under a variety of atmospheric and immersion exposure conditions and have good resistance to many chemicals and solvents. As a result, numerous industries including maintenance, marine, construction, architectural, aircraft and product finishing have adopted broad usage of epoxy coating materials.

The most common material utilized in the epoxy coating industry today is a multi-part epoxy material. In general, the epoxy includes a first base resin matrix formed from a bisphenol material such as bisphenol A (BPA) and at least a second catalyst or hardener, although other components such as a pigment agent or an aggregate component may also be added. While the two parts remain separate, they remain in liquid form. After the two parts are mixed, they begin a curing process that is typically triggered by exposure to environmental heat, humidity or an ultra-violet light source, whereby the mixed material quickly begins to solidify. As a result, it is necessary to mix only a sufficient amount of compound such that it can be worked effectively before setting up occurs. Accordingly, the use and application of these compounds is a tedious, slow and expensive proposition.

The hardeners are typically nitrogen-containing bases that are well known to the person skilled in the art as curing agents or curing accelerators for epoxy resins. Such systems have, however, only limited storage stability once mixed, because those bases react with epoxides even at relatively low temperature, in some cases even at room temperature, which is manifested in an increase in the viscosity of the epoxy resin formulation and, on prolonged storage, results in hardening of the mixture. The greater the reactivity of the nitrogen-containing base, the lower the storage stability of the epoxy resin mixture and the shorter the pot life. For that reason, such systems are formulated as two-component systems, that is to say the epoxy resin and the nitrogen-containing base are stored separately and mixed only shortly before processing or application.

There has been no shortage of attempts at improving the storage stability of such systems by developing appropriate curing systems. The problem posed is particularly complex because, at the same time as the requirement for a high storage stability and a long pot life, there should not be any deterioration either in the reactivity at the desired curing temperature or in the properties of the fully cured materials. For example, adsorption techniques have been used to control and modify various types of chemical reactions. These techniques usually involve adsorbing a chemical reagent in an adsorbent material. Commonly used adsorbent materials for this purpose are materials having internal pore structure and active pore sites, and can consist of silica gel, certain types of carbon black, activated charcoal, and the like. In practice, when using an adsorbed chemical reagent in a process involving a controlled chemical reaction, the adsorbed chemical reagent and adsorbent is admixed with the reacting component at relatively low temperatures and subsequently heated to desorb the adsorbed component. Heating the adsorbent and adsorbate product desorbs the adsorbate reagent reactant making it available for a reaction with a reacting component. The mixture prior to being activated is relatively inert and fairly safe to handle.

While the aforementioned reagent adsorption process solves many of the problems in regard to process control, handling etc., there is often still a slow escape of the chemical reagent from the adsorbent. In many instances, this slow escape of chemical reagent from the adsorbent creates problems. The desorbed chemical reagent if in a reactive environment or reactive medium will allow a slow reaction between reagents to proceed. If the rate of escape of reactant is large and the resulting reaction is exothermic there is a possibility that the exothermic heat effect will generate sufficient heat in the mixture to desorb and activate the entire mixture, or at least accelerate desorption. Further, the slow escape of chemical reagent will cause product deterioration, and shortened shelf life of an adsorbed component mixture. In general, depending on the type of adsorbent and adsorbate chemical reagent, the rate of escape of adsorbate from adsorbent will vary. Even a small escape of adsorbate is objectionable and in certain instances can cause very serious effects.

In the reagent adsorption techniques known to the prior art, adsorbed chemical reagent when present in a surrounding medium containing a reactive medium, is not rendered completely inert. In general, an adsorbent has an open pore structure. A portion of the adsorbed chemical reagent is in immediate contact with the reactive medium and is therefore in a potentially reactive position. The adsorbed chemical reagent molecules, even though attracted and held in the active pore sites by Van der Waals forces will often be dislodged from the adsorbent by the normal molecular vibration of the chemical components and will be free to react with the reactive medium. The tendency to dislodge the adsorbed adsorbate and the seriousness of this effect will vary with the type of adsorbate, the adsorbent and the reactive medium and the other possible components having a tendency to displace the adsorbate. Normally, the function of the adsorbent is to prevent or delay a reaction between the adsorbed chemical reagent and a reactive surrounding medium.

The more efficiently this function is performed, in general, the more desirable is the adsorption system. Therefore, adsorption of chemical reagents known to the prior art will not produce complete inertness, of a chemical reagent. Further, if the adsorbent in the chemical reagent combination is selected so that the adsorbate is very securely attached to the adsorbent, thus producing a very inert adsorbent adsorbate combination, it may require an extremely powerful displacing agent or heat effect to activate the material. For example, when the adsorbent adsorbate must be heated to extremely high temperatures in order to desorb the adsorbed reagent, other reagents in the mixture may be decomposed. This effect may completely prohibit the use of an adsorbed chemical reagent. An example is a decomposable blowing agent in a foamable mixture that will cure at a relatively low temperature. If the mixture is heated high enough to desorb the blowing agent, the reaction may proceed too rapidly and scorch, burn or cure the resin poorly.

In view of the foregoing, there is a need for a delayed curing epoxy resin composition. Further, there is a need for a delayed curing epoxy resin wherein the hardener and resin components can be fully blended, yet the curing reaction still be delayed to provide the composition with a long pot life. There is still a further need for method of lining a pipe system whereby a liner is fully impregnated (wet out) with a blended two part epoxy composition, yet the curing reaction is delayed for an extended period allowing the wet out liner to be stored and installed before the reaction is activated. Additionally, there is further need for alternative curing methodologies that utilize Ultra-Violet (UV) light energy, thermal energy, or a combination of both to initiate the curing reaction and allow for faster, more efficient installation of the pipe lining system.

### BRIEF SUMMARY OF THE INVENTION

In this regard, the present invention relates to a new resin composition and method for installing a pipe liner that allows the liner to be fully wet out with a mixed resin and activator composition and stored for a period of up to six months prior to installation and curing. Further the present invention provides a method of lining a pipe with a delayed curing photoinitiated and thermally activated resin composition that includes fully wetting out a liner with a blended two-part epoxy composition such that the liner can be transported in a wet out fashion, placed in a pipe to be lined and repositioned as needed without concern for the resin composition to begin curing until exposed to ultra-violet light, thermal energy, or a combination of both.

The new resin is a base resin composition consisting of a blend of anhydrides, bisphenol A, and bisphenol F resins. The resin blend is combined with proprietary activator components and photoinitiator chemicals to create a new epoxy composition that has an extended shelf life of up to six months after the base resin is mixed with the activator and photoinitiator components. This composition provides for a resin wherein the curing process can be delayed indefinitely prior to the application of a specific threshold of heat, ultraviolet radiation or a combination thereof.

Another unique feature is that in the prior art, the resins of the present invention would fail when applied in a wet condition. In the known industry, anhydrides based epoxies will not stick or have any adhesion at all to a wet surface. Further, other epoxy resins and the amino amine activators will not have strong adhesion to wet substrates. In contrast, the resin composition, as a result of the activator component disclosed herein, allows the composition to adhere to and cure on saturated wet surfaces.

In accordance with the method of the present invention, the method targets the cured in place liner industry for potable water lines, especially asbestos and lead lined pipe. The method will also target the wastewater pipeline rehabilitation industry, with the ability to provide a thinner, stronger cured in place liner system that is styrene free. The benefit to the industry is that the pipe lining bags can be wetted out in factory conditions and shipped across the country without the need of refrigerated transport trailers. The other major benefit is, once the bag reaches the job site, there is no reason to rush or hurry the installation process. The mixed resin installed in the liner at the factory will have a shelf life of up to 90 days without any chance of an exothermic reaction causing cure resulting in losing the bag, or the threat of spontaneous combustion which can happen with other wetted out liners. Installation methods using techniques known in the UV-light cured in place liner industry can be utilized to cure the liner system.

Therefore, it is an object of the present invention to provide a photoinitiated delayed curing epoxy resin composition. Further, it is an object of the present invention to provide a delayed curing epoxy resin wherein the hardener and resin components can be fully blended, yet the curing reaction still be delayed to provide the composition with a long pot life. It is still a further object of the present invention to provide a method of lining a pipe system whereby a liner is fully wet out with a blended two-part epoxy composition yet the curing reaction is delayed for an extended period allowing the wet out liner to be stored and installed before the reaction is activated using UV-light energy, thermal energy or a combination thereof.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### DETAILED DESCRIPTION OF THE INVENTION

Disclosed herein is a resin composition and method for installing a pipe liner that allows the liner to be fully wet out with a resin and activator and stored for a period of up to six months prior to installation and curing. Further, the present invention discloses a method of lining a pipe with a delayed curing resin composition that includes fully wetting out a liner with a blended two-part epoxy composition such that the liner can be transported in a wet out fashion, placed in a pipe to be lined and repositioned as needed without concern for the resin composition to begin curing until exposed to ultra-violet light, thermal energy, or a combination of both.

The composition of the present invention is a new blended resin composition consisting of a blend of cyclic anhydrides, bisphenol A, and bisphenol F resins. While single component, heat cured epoxy compositions have been disclosed in the past, the blended components have a relatively short shelf life and require that, once blended, the one component epoxy must be stored and transported in refrigeration. The resin blend of the present invention is combined with a proprietary activator and photo initiator component blend to create a new epoxy composition that has an extended shelf life of up to six months after the base resin is mixed with the activator and initiator components. This composition provides for a resin wherein the curing process can be delayed indefinitely prior to the application of a specific threshold of heat, ultraviolet radiation or a combination thereof.

It is known that primary and secondary amines and their epoxy-adducts are the most widely used activators for epoxy resins. The selection of an activator plays an important role in determining the final performance of the epoxy-amine thermoset. The ethyleneamine hardeners such as tetraethylenepentamine (TEPA), when cured with epoxy resins, provide excellent reactivity and physical properties including excellent chemical and solvent resistance but are brittle and have limited flexibility and toughness. However, it is also well known that these ethyleneamines have poor compatibility with epoxy resins and will blush under humid conditions. In wet conditions, the activators can exude to the surface during cure and react with atmospheric carbon dioxide and moisture to form undesirable carbamates also known as ‘blush’.

The activator of the present composition is a composition that preblends the TEPA activator in an activator preblend composition composed of a small percentage of liquid bisphenol, granular bisphenol and the tetraethylenepentamine (TEPA) activator. The activator is fully blended in a manner that overcomes the issues previously known when utilizing TEPA activators. The photo initiator combination is centered around use of 2,2-dimethoxy-2-phenylacetophenone (DMPA) and other photopolymerization chemicals that allow for fast reaction and high conversions at relatively low concentrations when exposed to UV light, without the reliance on amines as coinitiators. This preblend activator and photo initiator mixture is then combined with the base resin material. In the prior art, if the base resin were to be mixed without the activator of the present invention, the resin composition begins to cure in 48 hours into an unworkable gel. However, with the activator and photo initiator preblend composition disclosed herein, the blended, one component composition remains fully liquid and workable having a pot life of up to six months.

Another unique feature is that in the prior art the resins of the present invention would fail when applied in a wet condition. In the known industry, anhydrides based epoxies will not stick or have any adhesion at all to a wet surface. Further, other epoxy resins and the amino amine activators will not have strong adhesion to wet substrates. In contrast, the resin composition, as a result of the activator component disclosed herein, allows the composition to adhere to and cure on saturated wet surfaces.

The liner system utilizes existing installation methods commonly used for UV-light cured cured in place pipe liner systems. Once the liner is placed within the host pipe, pre-inspected and everything is satisfactory, compressed air is then applied to inflate the liner and create a tight fit to the host pipe. A UV-light apparatus is inserted into the placed liner and positioned to begin the curing process. The UV-light curing apparatus is then pulled through the pipe at a prescribed rate of speed based on liner thickness and other design parameters, applying sufficient UV light energy to initiate the polymerization process. As the photoinitiated chemicals react, temperatures within the resin rise quickly and initiate the thermal activator components to produce a secondary reaction to complete the curing process. Heat emitted by mercury-arc UV lights used for curing may also contribute to the polymerization of the resin materials. In addition, a clear inflation bladder can be employed such that ultraviolet illumination of the material can be applied to commence the curing process. The material will spike out in between 380 and 400° on the exotherm, and this will give a much higher operating temperature capability for the finished lined pipe. It should be appreciated that the liner of the present invention may be inflated using a calibration hose, however, many liners currently in use have an airtight layer formed therein that allows inflation of the liner without the need for a calibration hose.

Not only can the new resin be used for drinking water, raw water, wastewater and fuel lines, it can also be used for high temperature applications such as steam and steam return lines. We believe this new resin will revolutionize this industry worldwide and lead the way into the future for non-toxic, totally reliable, very strong products with superior heat and chemical resistance capabilities for future generations. We believe this material will have an expected life exceeding 100 years in the ground based on private testing conducted at the University of Pittsburgh and the University of South Carolina.

In accordance with the process of the present invention, the inside surface of the pipeline, to be repaired, is first prepared to remove debris and dirt, as will be described in detail below. Preferably, the inner wall surfaces of the pipeline are cleaned by injecting highly pressurized water into the pipeline. The pressurized water stream strikes the inside walls forcefully and scrubs the walls. For example, the water can be provided at up to 30,000 psi to ensure a clean surface. Even higher pressure can be used along with abrasive blasting methods, if necessary. Known water spraying devices (water blasting or water jetting, depending on level of preparation required) are used for this step of the process. The injected water substantially removes the foreign debris to leave a clean inner wall surface remaining. While high-pressure water is preferably used, air or steam may be used instead. Also, additional cleaning agents are not preferably used but such cleaning agents could be added to the water, air or steam to assist in cleaning depending the application and environment.

After surface cleaning is complete, any significant standing water left remaining, such as that on the bottom of the pipeline, must be removed. High-pressure air, using known air blowing equipment, is injected into the pipeline to clear it of any remaining water and cleaning media. Swabbing methods may also be employed as necessary depending on the application. A flexible liner tube, which has been fully wet out with the preblend resin composition of the present disclosure is prepared and positioned in the pipeline. The liner tube is inserted into the pipeline by techniques known in the industry. The liner tube is pulled or winched into the pipeline in a collapsed state using a cable and winch-operating system that, for example, can use ¼ inch aircraft cable. The liner tube is introduced directly into the pipeline, so that it rests on the bottom surface of the host pipe. The flexible liner tube includes an outer layer that surrounds an inner layer. The outer layer can be made from any suitable material that is rugged and which will adhere to the resin and will protect the liner from UV light exposure prior to installation. Typically, the outer layer is made from a plastic material such as polyvinyl chloride, polyurethane, polyethylene, polypropylene, polyester, polyamide, or the like.

The inner layer is a layer of non-woven fibrous material (felt) or woven fiberglass, permanently adhered to the outer layer of the liner tube. The felt or fiberglass matrix inner layer is provided as a suitable resin-absorbing material. For unreinforced liner applications, polyester-needled felt materials can be used to form the inner layer, whereas woven fiberglass may be utilized when reinforced liner applications are required. Both felt and fiberglass materials commonly used for cured in place pipe liner applications have good resin-absorbency properties. The felt or fiberglass matrix material soaks up the resin so that the inner layer becomes impregnated with the resin. The resin may be applied to the inner layer using vacuum or injection. Alternately, the liner tube may be filled with an amount of resin calculated to fully wet out the inner layer and the liner tube can be then drawn through rollers to squeeze the resin into the inner layer material. It is understood that the resin must be applied to the felt or fiberglass inner layer at an off-site facility and then transported to the pipeline site due to sensitivity of the resin blend to UV light.

Thus, the inner layer is impregnated with the resin in liquid form (“wet out”) prior to placing the liner tube in the pipeline. The resin is absorbed by and resides within the felt or fiberglass inner layer. Thus, the felt or fiberglass inner layer serves as a carrier for the resin.

In accordance with the method of the present invention, the method targets the cured in place pipe liner industry for potable water lines, especially asbestos and lead lined pipe. The method will also target the wastewater pipeline rehabilitation industry, with the ability to provide a thinner, stronger cured in place liner system that is styrene free. The benefit to the industry is that the pipe lining bags can be wetted out in controlled factory conditions and shipped across the country in UV-light resistant containers without the need of refrigerated transport trailers. The other major benefit is, once the liner reaches the job site, there is no reason to rush or hurry the installation process. As long as the liner is not exposed to UV light or temperatures exceeding 160 degrees Fahrenheit, the mixed resin installed in the liner at the factory will have a shelf life of up to 90 days without any chance of an exothermic reaction causing a premature cure resulting in losing the liner, or the threat of spontaneous combustion which can happen with other wetted out liners.

This method further allows for pre-inspection of the liner positioning and installation prior to curing, which is a common practice for other UV-light cured in place pipe liner methods. This process begins with attaching of a set of inflation can seals that go on to each end of the liner within the pipe to be lined. Once the inflation cans are in place, the liner can be inflated and pressurized with the use of an air compressor system to provide a tight fit to the host pipe. A pre-inspection camera that is typically integrated with the UV-light apparatus is winched into the line and inserted through a port in the inflation cans at one end. The pre-inspection camera is used to identify any defects or liner issues that could be detrimental to the final product prior to curing. At temperatures below 160 degrees Fahrenheit, and without UV light exposure, the liner bag can still be deflated, reworked and repositioned. If everything is deemed satisfactory after the pre-inspection, the UV light apparatus is turned on and pulled through the inflated liner at a prescribed rate and the curing process takes place.

In one embodiment, a calibration hose is introduced into the resin-saturated liner using techniques known in the industry. The calibration hose can be made from materials such as polyvinyl chloride, polyurethane, polyethylene, polypropylene, polyesters, polyamides, or the like. The calibration hose is not treated with a curing resin in the method of this invention. Most importantly, the calibration hose does not adhere to resin residing in the felt or fiberglass inner layer. The calibration hose is inserted so that an outer peripheral region is in communication with inner layer. The outer peripheral region is held in place by clamps or the like so that an inner region may be inverted therethrough. The calibration hose is filled with pressurized air. Further, in this embodiment a clear or UV transparent calibration hose is inverted into the pipeline and the liner tube using compressed air. As the pressurized air is directed into the middle region, the calibration hose is pulled via the inner region. The inverted calibration hose walks along the inside of the liner tube and expands and presses it against the inner wall of the pipeline.

The pressurized air makes the inverted calibration hose push against the flexible liner tube and forces the liner tube outwardly so that it presses against and engages the interior walls of the pipeline, resulting in a tight fit with minimal annular gap. As a result, the lining hose contacts and conforms to the shape of the internal pipeline walls. Due to the durability of the liner, joint sections are adequately accommodated as the liner tube is expanded and stretched to the contours of the inner wall surfaces of the pipeline.

The compressed air leaves the internal space within the calibration hose empty thereby allowing the introduction of a UV light apparatus that can be placed or winched within the calibration hose thereby penetrating the transparent walls of the calibration hose to initiate the curing process with ultraviolet light energy followed by a thermal reaction to harden the resin. The curing reaction is exothermic so the curing of the resin, itself, generates heat that further improves the curing rate. Also, in addition to UV curing agents, the resin may contain additional heat-initiated curing agents that accelerate the curing process. Upon the curing and hardening of the resin, the liner tube becomes a standalone liner system with a tight fit to the wall surfaces.

The calibration hose can then be removed from the liner using techniques known in the art. Typically, a rope or cable is attached to the trailing end of the calibration hose. An operator pulls on the rope or cable to remove the calibration hose from the lining hose.

Alternately, the curing of the lining hose may be accomplished by application of heat, ultraviolet radiation or a combination thereof directly to the installed liner itself.

The resulting pipeline is a repaired composite structure including the liner tube fit tightly to the inner surface of the host pipe. Depending on design requirements, the liner can be considered a fully structural, stand-alone system. The resulting composite pipeline structure is rigid and has good mechanical integrity thus providing a water-tight and sealed monolithic structure. The method of the present invention provides a smooth and continuous interior surface, and the structural integrity of the host pipe is greatly improved when a lining is installed in accordance with the present invention.

Various other components may be included and called upon for providing for aspects of the teachings herein. For example, additional materials, combinations of materials and/or omission of materials may be used to provide for added embodiments that are within the scope of the teachings herein.

In the present application a variety of embodiments are described. It is to be understood that any combination of any of these variables can define an embodiment of the invention. For example, a combination of a particular dopant material, with a particular compound, applied in a certain manner might not be expressly stated, but is an embodiment of the invention. Other combinations of articles, components, conditions, and/or methods can also be specifically selected from among variables listed herein to define other embodiments, as would be apparent to those of ordinary skill in the art.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

Therefore, it can be seen that the present invention provides a delayed curing epoxy resin composition, wherein the hardener and resin components can be fully blended, yet the curing reaction still be delayed providing the composition with a long pot life. It can also be seen that the present invention to provides a method of lining a pipe system whereby a liner is fully wet out with a blended epoxy composition, yet the photoinitiated thermal curing reaction is delayed for an extended period allowing the wet out liner to be stored and installed before the reaction is activated.

What is claimed:

1. A delayed cure, single component resin composition comprising:
a base resin containing a blend of cyclic anhydride, bisphenol A and bisphenol F resins; and
an activator comprising;
tetraethylenepentamine;
liquid bisphenol;
granular bisphenol; and
a photoinitiated polymerization agent,
all blended to form an activator preblend;
wherein said activator preblend and base are fully blended providing a one component resin composition having an extended workable pot life.

2. The single component resin composition of claim 1, wherein said single component resin remains liquid at temperatures below a threshold curing temperature.

3. The single component resin composition of claim 1, wherein said single component resin remains liquid until exposed to ultraviolet light energy.

4. The single component resin composition of claim 1, wherein said photoinitiated polymerization agent is 2,2-dimethoxy-2-phenylacetophenone (DMPA), or other compatible photoinitiator chemicals.

5. The single component resin composition of claim 1, wherein said activator preblend allows application of said resin composition to wet substrates.

6. The single component resin composition of claim 1, wherein said blended composition has a usable storage life of up to 6 months.

7. A delayed cure, pipe lining composition comprising:
a single component resin composition, comprising:
a base resin containing a blend of cyclic anhydride, bisphenol A and bisphenol F resins; and
an activator comprising;
tetraethylenepentamine;
liquid bisphenol;
granular bisphenol; and
a photoinitiated polymerization agent,
all blended to form an activator preblend;
wherein said activator preblend and base are fully blended; and
a pipe lining composite fully wet out with said fully blended activator and base providing a pipe lining composition having an extended workable pot life.

8. The delayed cure, pipe lining composition of claim 7, wherein said single component resin remains liquid at temperatures below a threshold curing temperature.

9. The delayed cure, pipe lining composition of claim 7, wherein said single component resin remains liquid until exposed to ultraviolet light energy.

10. The delayed cure, pipe lining composition of claim 7, wherein said photoinitiated polymerization agent is 2,2-dimethoxy-2-phenylacetophenone (DMPA), or other compatible photoinitiator chemicals.

11. The delayed cure, pipe lining composition of claim 7, wherein said activator preblend allows application of said pipe lining composition to wet substrates.

12. The delayed cure, pipe lining composition of claim 7, wherein said pipe lining composition has a usable storage life of up to 6 months.

13. A method of lining a pipe using delayed cure, pipe lining composition comprising:
providing a single component resin composition, comprising:
a base resin containing a blend of cyclic anhydride, bisphenol A and bisphenol F resins; and
an activator comprising;
tetraethylenepentamine;
liquid bisphenol;
granular bisphenol; and
a photoinitiated polymerization agent,
all blended to form an activator preblend;
wherein said activator preblend and base are fully blended;
providing a pipe lining composite;
fully wetting out said pipe lining composite with said fully blended activator and base providing a pipe lining composition having an extended workable pot life;
inserting said pipe lining composite into a pipe to be repaired;
inflating said pipe lining composite; and
curing said pipe lining composite.

14. The method of lining a pipe of claim 13, said step of curing comprising:
exposing said inflated pipe lining composite to ultraviolet light energy, heat energy or combinations thereof.
